(19) United States
(12) Patent Application Publication
(10) Pub. No.: US 2024/0330786 A1
(43) Pub. Date: Oct. 3, 2024

(54) PICKUP AND DROP-OFF VEHICLE MANAGEMENT SYSTEM AND PICKUP AND DROP-OFF VEHICLE MANAGEMENT METHOD

(71) Applicant: HONDA MOTOR CO., LTD., Tokyo (JP)

(72) Inventors: Junichiro Kano, Wako-shi (JP); Yuho Yamazaki, Wako-shi (JP)

(21) Appl. No.: 18/443,015

(22) Filed: Feb. 15, 2024

(30) Foreign Application Priority Data
Mar. 28, 2023 (JP) 2023-052062

(51) Int. Cl. G06Q 10/02; G06Q 30/0208

(52) U.S. Cl. CPC G06Q 10/025; G06Q 30/0208

(57) ABSTRACT

A pickup and drop-off vehicle management system includes: a dispatch cancellation confirmation section; and a dispatched pickup and drop-off vehicle changing section. The dispatch cancellation confirmation section transmits dispatch cancellation confirmation information to a driver terminal when a substitution pickup and drop-off vehicle extraction section extracts a second pickup and drop-off vehicle. The dispatch cancellation confirmation information is for asking whether to accept the cancellation of reservation-based dispatch. The dispatched pickup and drop-off vehicle changing section cancels the arrangement of the reservation-based dispatch of a first pickup and drop-off vehicle when dispatch cancellation request information is received and arranges dispatch of a second pickup and drop-off vehicle that covers a target flight after a delay in estimated arrival time or a change of an arrival point.

### INCORPORATION BY REFERENCE

The present application claims priority under 35 U.S.C. § 119 to Japanese Patent Application No. 2023-052062 filed on Mar. 28, 2023. The content of the application is incorporated herein by reference in its entirety.

### BACKGROUND OF THE INVENTION

### Field of the Invention

The present invention relates to a pickup and drop-off vehicle management system and a pickup and drop-off vehicle management method.

### Description of the Related Art

Conventionally, technologies related to the dispatch of a pickup and drop-off vehicle have been proposed. For example, Japanese Patent Laid-Open No. 2023-3865 discloses technology of switching a pickup and drop-off vehicle reserved for dispatch to another pickup and drop-off vehicle having a lower movement cost to the pickup place of a user. Further, Japanese Patent Laid-Open No. 2023-3865 discloses technology of having a pickup and drop-off vehicle stand by at another pickup and drop-off place for time adjustment when a delay is detected in the arrival time of the user to the pickup place and it is difficult for the pickup and drop-off vehicle to park at the pickup place for a long time.

In addition, U.S. Pat. No. 10,837,786 discloses technology of delaying or advancing a flight in accordance with a deviation from a travel schedule on a first land route and delaying or advancing a travel schedule on a second land route in accordance with a deviation from a travel schedule on an air route in a multi-modal travel itinerary in which land routes and air routes are combined.

An aircraft flight is likely to be influenced by the weather and the influence of the weather may cause the arrival time to be delayed and may cause the arrival point to be changed in some cases. When a user of an aircraft has a reservation of a pickup and drop-off vehicle with the arrival location of the flight as a pickup place and if the arrival time is delayed, then a driver of the pickup and drop-off vehicle stands by at the pickup place for a longer time and disadvantageously has a temporal loss and an economic loss. In addition, if the arrival point is changed, then the driver of the pickup and drop-off vehicle may have to move to another arrival point from the original arrival point or the reservation of the dispatch may be canceled in some cases, which disadvantageously causes a temporal loss and an economic loss for the driver.

It is thus conceivable to automatically cancel the reservation of the dispatch in accordance with the changed flight schedule, but this inconveniently disrupts the movement of the user having the reservation of the pickup and drop-off vehicle from the arrival location of the flight. The related art mentioned above fails to deal with such an inconvenience caused by the changed flight schedule.

The present invention has been devised in view of this background and an object of the present invention is to provide a pickup and drop-off vehicle management system and a pickup and drop-off vehicle management method that make it possible to reduce losses that a driver of a pickup and drop-off vehicle reserved for dispatch with the arrival location of a flight as a pickup place may have due to the changed flight schedule while avoiding disrupting the movement of the user having the reservation of the dispatch from the arrival location.

### SUMMARY OF THE INVENTION

A first aspect for achieving the object described above includes a pickup and drop-off vehicle management system including: a dispatch status information obtaining section; a pickup and drop-off vehicle reservation acceptance section; a reservation-based dispatch arrangement section; a flight operation information obtaining section; a substitution pickup and drop-off vehicle extraction section; a dispatch cancellation confirmation section; and a dispatched pickup and drop-off vehicle changing section. The dispatch status information obtaining section is configured to obtain dispatch status information indicating a dispatch status of each of a plurality of pickup and drop-off vehicles. The pickup and drop-off vehicle reservation acceptance section is configured to receive pickup and drop-off reservation request information transmitted from a user terminal that is used by a user who wants to use a pickup and drop-off vehicle, and accept a reservation of a pickup and drop-off vehicle by the user. The reservation-based dispatch arrangement section is configured to extract, on the basis of the dispatch status information, a first pickup and drop-off vehicle available to reservation-based dispatch which meets a dispatch reservation condition, and arrange the reservation-based dispatch of the first pickup and drop-off vehicle. The dispatch reservation condition is indicated by the pickup and drop-off reservation request information. The flight operation information obtaining section is configured to obtain flight operation information when the reservation-based dispatch uses an arrival point of a target flight as a pickup point of the user and the estimated pickup time of the reservation-based dispatch is set in association with the estimated arrival time of the target flight at the arrival point. The target flight is used by the user. The flight operation information indicates an operation status of the target flight. The substitution pickup and drop-off vehicle extraction section is configured to execute at least one of first substitution pickup and drop-off vehicle extraction processing and second substitution pickup and drop-off vehicle extraction processing. The first substitution pickup and drop-off vehicle extraction processing extracts, when a delay is recognized in the estimated arrival time of the target flight on the basis of the flight operation information, a second pickup and drop-off vehicle available to dispatch for the estimated arrival time after the delay on the basis of the dispatch status information. The second substitution pickup and drop-off vehicle extraction processing extracts, when a change of the arrival point of the target flight is recognized on the basis of the flight operation information, a second pickup and drop-off vehicle available to dispatch at the arrival point after the change on the basis of the dispatch status information. The dispatch cancellation confirmation section is configured to transmit dispatch cancellation confirmation information to a driver terminal when the substitution pickup and drop-off vehicle extraction section extracts the second pickup and drop-off vehicle. The driver terminal is used by a driver of the first pickup and drop-off vehicle. The dispatch cancellation confirmation information is for asking whether to accept the cancellation of the reservation-based dispatch. The dispatched pickup and drop-off vehicle changing section is configured to cancel the arrangement of the reservation-based dispatch of the first pickup and drop-off vehicle when dispatch cancellation request information is received, and arrange dispatch of the second pickup and drop-off vehicle applicable to the target flight after the delay in the estimated arrival time or the change of the arrival point. The dispatch cancellation request information is transmitted from the driver terminal upon reception of the dispatch cancellation confirmation information, the dispatch cancellation request information being for requesting the reservation-based dispatch to be canceled.

In the pickup and drop-off vehicle management system described above, the dispatch cancellation confirmation information may be configured to include information related to a demand for dispatching the first pickup and drop-off vehicle that is idle due to the cancellation of the reservation-based dispatch.

In the pickup and drop-off vehicle management system described above, the dispatch cancellation confirmation section may be configured to transmit the dispatch cancellation confirmation information to the driver terminal when a delay time of the estimated arrival time of the target flight is less than a predetermined time or when a distance between an arrival point of the target flight after the change and the arrival point before the change is less than a predetermined distance, and the dispatched pickup and drop-off vehicle changing section may be configured to cancel the arrangement of the reservation-based dispatch of the first pickup and drop-off vehicle regardless of reception of the dispatch cancellation request information from the driver terminal and arrange the dispatch of the second pickup and drop-off vehicle when the delay time of the estimated arrival time of the target flight is more than or equal to the predetermined time or when the distance between the arrival point of the target flight after the change and the arrival point before the change is more than or equal to the predetermined distance.

The pickup and drop-off vehicle management system described above may include a driver selection condition information obtaining section configured to obtain driver selection condition information indicating a selection condition for a driver of a pickup and drop-off vehicle designated by the user. In the pickup and drop-off vehicle management system described above, the substitution pickup and drop-off vehicle extraction section may be configured to extract the second pickup and drop-off vehicle from pickup and drop-off vehicles to be driven by drivers who satisfy the selection condition indicated by the driver selection condition information.

The pickup and drop-off vehicle management system described above may include an additional reward imparting section configured to execute processing for imparting an additional reward to the driver of the first pickup and drop-off vehicle when the driver of the first pickup and drop-off vehicle does not cancel the reservation-based dispatch and stands by to cover the delay in the estimated arrival time of the target flight or covers a change of the pickup point of the user corresponding to the change of the arrival point of the target flight.

A second aspect for achieving the object described above includes a pickup and drop-off vehicle management system including: a dispatch status information obtaining section; a pickup and drop-off vehicle reservation acceptance section; a reservation-based dispatch arrangement section; a user movement information obtaining section; a substitution pickup and drop-off vehicle extraction section; a dispatch cancellation confirmation section; and a dispatched pickup and drop-off vehicle changing section. The dispatch status information obtaining section is configured to obtain dispatch status information indicating a dispatch status of each of a plurality of pickup and drop-off vehicles. The pickup and drop-off vehicle reservation acceptance section is configured to receive pickup and drop-off reservation request information transmitted from a user terminal that is used by a user who wants to use a pickup and drop-off vehicle, and accept a reservation of a pickup and drop-off vehicle by the user. The reservation-based dispatch arrangement section is configured to extract, on the basis of the dispatch status information, a first pickup and drop-off vehicle available to reservation-based dispatch which meets a dispatch reservation condition, and arrange the reservation-based dispatch of the first pickup and drop-off vehicle. The dispatch reservation condition is indicated by the pickup and drop-off reservation request information. The user movement information obtaining section is configured to obtain user movement information indicating a movement status of the user. The substitution pickup and drop-off vehicle extraction section is configured to execute at least one of first substitution pickup and drop-off vehicle extraction processing and second substitution pickup and drop-off vehicle extraction processing. The first substitution pickup and drop-off vehicle extraction processing extracts, when a delay is recognized in arrival of the user with respect to the estimated pickup time at the pickup point set by the reservation-based dispatch on the basis of the user movement information, a second pickup and drop-off vehicle available to dispatch for the estimated arrival time after the delay on the basis of the dispatch status information. The second substitution pickup and drop-off vehicle extraction processing extracts, when a change of the pickup point of the user from the pickup point set by the reservation-based dispatch is recognized on the basis of the user movement information, a second pickup and drop-off vehicle available to dispatch at the pickup point after the change on the basis of the dispatch status information. The dispatch cancellation confirmation section is configured to transmit dispatch cancellation confirmation information to a driver terminal when the substitution pickup and drop-off vehicle extraction section extracts the second pickup and drop-off vehicle. The driver terminal is used by a driver of the first pickup and drop-off vehicle. The dispatch cancellation confirmation information is for asking whether to accept the cancellation of the reservation-based dispatch. The dispatched pickup and drop-off vehicle changing section is configured to cancel the arrangement of the reservation-based dispatch of the first pickup and drop-off vehicle when dispatch cancellation request information is received, and arrange dispatch of the second pickup and drop-off vehicle that covers the delay of the user to the pickup point or the change of the pickup point of the user. The dispatch cancellation request information is transmitted from the driver terminal upon reception of the dispatch cancellation confirmation information. The dispatch cancellation request information is for requesting the reservation-based dispatch to be canceled.

A third aspect for achieving the object described above includes a pickup and drop-off vehicle management method that is executed by a computer. The pickup and drop-off vehicle management method including: a dispatch status information obtaining step of obtaining dispatch status information indicating a dispatch status of each of a plurality of pickup and drop-off vehicles; a pickup and drop-off vehicle reservation acceptance step of receiving pickup and drop-off reservation request information transmitted from a user terminal that is used by a user who wants to use a pickup and drop-off vehicle, and accepting a reservation of a pickup and drop-off vehicle by the user; a reservation-based dispatch arrangement step of extracting, on the basis of the dispatch status information, a first pickup and drop-off vehicle available to reservation-based dispatch which meets a dispatch reservation condition, and arranging the reservation-based dispatch of the first pickup and drop-off vehicle; a flight operation information obtaining step of obtaining flight operation information when the reservation-based dispatch uses an arrival point of a target flight as a pickup point of the user and the estimated pickup time of the reservation-based dispatch is set in association with the estimated arrival time of the target flight at the arrival point, the target flight being used by the user; a substitution pickup and drop-off vehicle extraction step of executing at least one of first substitution pickup and drop-off vehicle extraction processing of extracting, when a delay in the estimated arrival time of the target flight is recognized on the basis of the flight operation information, a second pickup and drop-off vehicle available to dispatch for the estimated arrival time after the delay on the basis of the dispatch status information and second substitution pickup and drop-off vehicle extraction processing of extracting, when a change of the arrival point of the target flight is recognized on the basis of the flight operation information, a second pickup and drop-off vehicle available to dispatch at an arrival point after the change on the basis of the dispatch status information; a dispatch cancellation confirmation step of transmitting dispatch cancellation confirmation information to the driver terminal when the second pickup and drop-off vehicle is extracted in the substitution pickup and drop-off vehicle extraction step; and a dispatched pickup and drop-off vehicle changing step of canceling the arrangement of the reservation-based dispatch of the first pickup and drop-off vehicle when dispatch cancellation request information is received, and arranging dispatch of the second pickup and drop-off vehicle that covers the target flight after the delay in the estimated time of the arrival or the change of the arrival point. The dispatch reservation condition is indicated by the pickup and drop-off reservation request information. The flight operation information indicates an operation status of the target flight. The driver terminal is used by a driver of the first pickup and drop-off vehicle. The dispatch cancellation confirmation information is for asking whether to accept the cancellation of the reservation-based dispatch. The dispatch cancellation request information is transmitted from the driver terminal upon reception of the dispatch cancellation confirmation information. The dispatch cancellation request information is for requesting the reservation-based dispatch to be canceled.

According to the pickup and drop-off vehicle management system and the pickup and drop-off vehicle management method described above, it is possible to reduce losses that a driver of a pickup and drop-off vehicle reserved for dispatch with the arrival location of a flight as a pickup place may have due to the changed flight schedule while avoiding disrupting the movement of the user having the reservation of the dispatch from the arrival location.

### BRIEF DESCRIPTION OF THE DRAWINGS

FIG. 1 is an explanatory diagram in which a pickup and drop-off vehicle management system arranges a pickup and drop-off vehicle;

FIG. 2 is a configuration diagram of the pickup and drop-off vehicle management system;

FIG. 3 is a first flowchart of dispatched pickup and drop-off vehicle changing processing; and

FIG. 4 is a second flowchart of the dispatched pickup and drop-off vehicle changing processing.

### DETAILED DESCRIPTION OF THE PREFERRED EMBODIMENTS

### 1. Arrangement of Pickup and Drop-off Vehicle by Pickup and Drop-off Vehicle Management System

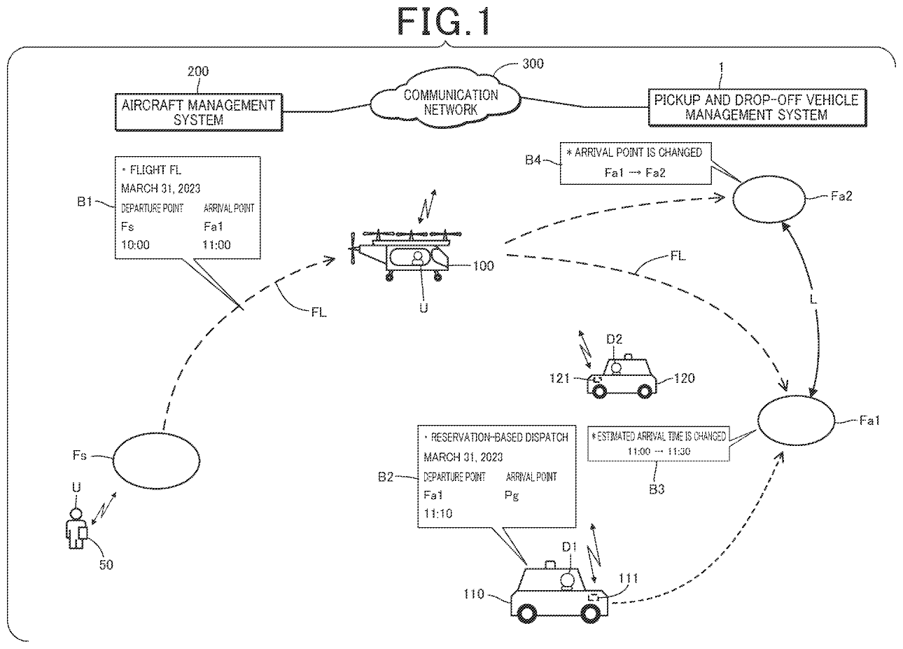

An aspect in which a pickup and drop-off vehicle management system 1 according to the present embodiment arranges a pickup and drop-off vehicle will be described with reference to FIG. 1. FIG. 1 exemplifies a situation in which a user U rides an aircraft 100 to move from a port Fs that is a departure point to a port Fa1 that is an arrival point on a flight FL, and has a reservation of the dispatch of a first pickup and drop-off vehicle 110 as transportation means from the port Fa1.

The aircraft 100 is, for example, an electric vertical take-off and landing aircraft (eVTOL). The pickup and drop-off vehicle management system 1 manages the dispatch of a plurality of pickup and drop-off vehicles. FIG. 1 exemplifies the first pickup and drop-off vehicle 110 and a second pickup and drop-off vehicle 120.

The pickup and drop-off vehicle management system 1 communicates with an aircraft management system 200, a user terminal 50 that is used by the user U, a communication device 111 mounted on the first pickup and drop-off vehicle 110, and a communication device 121 mounted on the second pickup and drop-off vehicle 120 through a communication network 300. The communication device 111 corresponds to a driver terminal according to the present disclosure. The driver terminal may be a portable terminal (such as a smartphone, a mobile phone, or a tablet terminal) that is used by a driver D1.

The user U accesses the pickup and drop-off vehicle management system 1 by operating a pickup and drop-off vehicle reservation application installed in the user terminal 50, to reserve the dispatch of the first pickup and drop-off vehicle 110 with the port Fa1 as a pickup point. At the time of reserving the dispatch, the user U reports the arrival at the port Fa1 on the flight FL. The user terminal 50 is a smartphone, a mobile phone, a tablet terminal, or the like.

The aircraft management system 200 recognizes the operation status of the flight FL by receiving operation status information transmitted from the aircraft 100. The pickup and drop-off vehicle management system 1 recognizes the operation status of the flight FL by receiving and obtaining flight operation information indicating the operation status of the flight FL from the aircraft management system 200.

Here, the flight FL is originally scheduled to take off from the port Fs at 10:00 on Mar. 31, 2023 and arrive at the port Fa1 at 11:00 as illustrated in a speech balloon B1. According to this schedule, the user U then reserves a pickup and drop-off vehicle for 11:10 on the same day with the port Fa1 as a pickup point and Pg as a destination as illustrated in a speech balloon B2, and the dispatch (reservation-based dispatch) of the first pickup and drop-off vehicle 110 is arranged by this reservation.

Bad weather, delayed maintenance of the aircraft 100, or the like, however, may delay the flight FL in some cases as illustrated in a speech balloon B3. In this case, the first pickup and drop-off vehicle 110 stands by at the port Fa1 for a longer time, causing the driver D1 to have temporal and economic losses. In addition, bad weather may change the arrival point of the flight FL from the port Fa1 to Fa2 in some cases as illustrated in a speech balloon B4. In this case, if the distance L between the port Fa1 and the port Fa2 is great, the long-time movement of the first pickup and drop-off vehicle 110 from the port Fa1 to the port Fa2 also causes the driver D1 to have temporal and economic losses.

The pickup and drop-off vehicle management system 1 thus obtains operation information related to the flight FL from the aircraft management system 200 at the time of reservation-based dispatch and monitors whether a delay is caused in the estimated arrival time of the flight FL and the arrival point is changed. When a delay is caused in the estimated arrival time of the flight FL or the arrival point is changed, the pickup and drop-off vehicle management system 1 then searches for a second pickup and drop-off vehicle 120 available to dispatch which covers the delayed flight FL or the flight FL whose arrival point is changed in substitution for the first pickup and drop-off vehicle 110.

When the second pickup and drop-off vehicle 120 is extracted, the pickup and drop-off vehicle management system 1 then cancels the reservation-based dispatch of the first pickup and drop-off vehicle 110 and arranges the dispatch of the second pickup and drop-off vehicle 120 to the arrival location of the flight FL that covers the delayed flight FL or the flight FL whose arrival point is changed. This makes it possible to secure the transportation means for the user U from the arrival point of the flight FL and then offer support to reduce temporal and economic losses that the driver D1 of the first pickup and drop-off vehicle 110 may have.

### 2. Configuration of Pickup and Drop-off Vehicle Management System

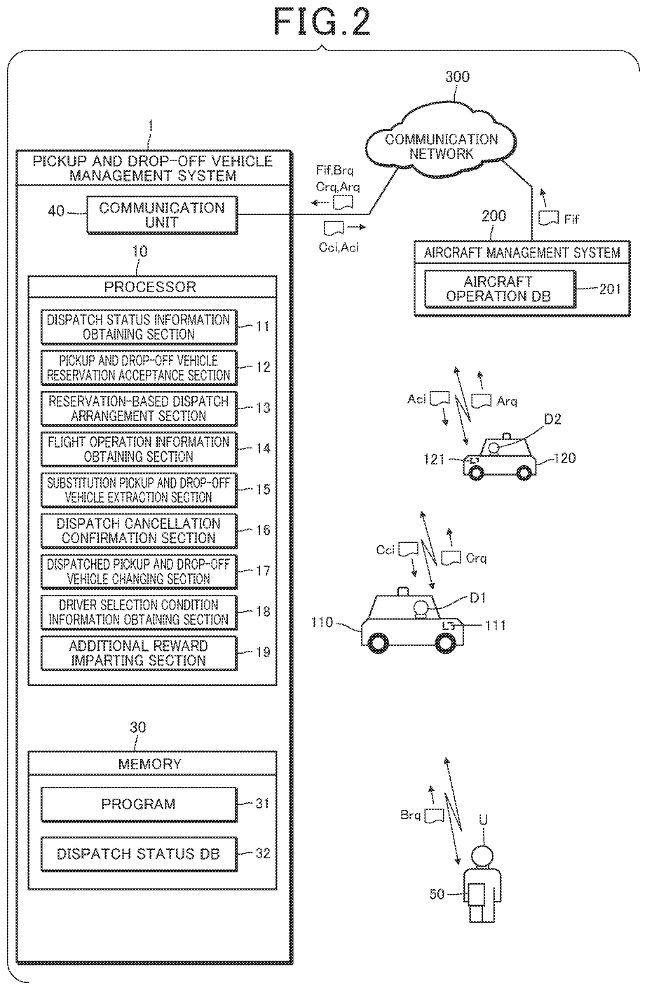

A configuration of the pickup and drop-off vehicle management system 1 will be described with reference to FIG. 2. Referring to FIG. 2, the pickup and drop-off vehicle management system 1 is a computer system including a processor 10, a memory 30, a communication unit 40, and the like. The pickup and drop-off vehicle management system 1 communicates through the communication network 300 using the communication unit 40 as described above.

A program 31, a dispatch status database (DB) 32, and the like are stored in the memory 30. A program 31 is used for controlling the pickup and drop-off vehicle management system 1. The dispatch status (including the availability, the reservation status, the movement status, the standby point, and the like) of each of a plurality of pickup and drop-off vehicles including the first pickup and drop-off vehicle 110 and the second pickup and drop-off vehicle 120 is recorded in the dispatch status DB 32.

A processor 20 reads and executes the program 31 to function as a dispatch status information obtaining section 11, a pickup and drop-off vehicle reservation acceptance section 12, a reservation-based dispatch arrangement section 13, a flight operation information obtaining section 14, a substitution pickup and drop-off vehicle extraction section 15, a dispatch cancellation confirmation section 16, a dispatched pickup and drop-off vehicle changing section 17, a driver selection condition information obtaining section 18, and an additional reward imparting section 19.

Processing to be executed by the dispatch status information obtaining section 11 corresponds to a dispatch status information obtaining step in the pickup and drop-off vehicle management method according to the present disclosure and processing to be executed by the pickup and drop-off vehicle reservation acceptance section 12 corresponds to a pickup and drop-off vehicle reservation acceptance step in the pickup and drop-off vehicle management method according to the present disclosure. Processing to be executed by the reservation-based dispatch arrangement section 13 corresponds to a reservation-based dispatch arrangement step in the pickup and drop-off vehicle management method according to the present disclosure and processing to be executed by the flight operation information obtaining section 14 corresponds to a flight operation information obtaining step in the pickup and drop-off vehicle management method according to the present disclosure.

Processing to be executed by the substitution pickup and drop-off vehicle extraction section 15 corresponds to a substitution pickup and drop-off vehicle extraction step in the pickup and drop-off vehicle management method according to the present disclosure and processing to be executed by the dispatch cancellation confirmation section 16 corresponds to a dispatch cancellation confirmation step in the pickup and drop-off vehicle management method according to the present disclosure. Processing to be executed by the dispatched pickup and drop-off vehicle changing section 17 corresponds to a dispatched pickup and drop-off vehicle changing step in the pickup and drop-off vehicle management method according to the present disclosure.

The dispatch status information obtaining section 11 receives dispatch status information, transmitted from a pickup and drop-off vehicle, indicating the availability, the traveling point, and the like of each pickup and drop-off vehicle and constantly records the received dispatch status information in the dispatch status DB 32. The pickup and drop-off vehicle reservation acceptance section 12 accepts a reservation of the dispatch of a pickup and drop-off vehicle by the user U upon receiving pickup and drop-off reservation request information Brq transmitted from the user terminal 50. The pickup and drop-off reservation request information Brq includes dispatch reservation conditions such as a pickup point, pickup time, and a selection condition (such as sex or a performance evaluation level) for a desired driver. Further, when the user U presents the use of a pickup and drop-off vehicle subsequent to the movement on the flight FL at the time of a reservation of a pickup and drop-off vehicle as illustrated in FIG. 1, the pickup and drop-off reservation request information Brq includes information indicating that the pickup point and the pickup time of the dispatch reservation conditions correspond to the arrival point and the estimated arrival time of an air route transportation.

The reservation-based dispatch arrangement section 13 extracts the first pickup and drop-off vehicle 110 available to reservation-based dispatch which meets the dispatch reservation conditions indicated by the pickup and drop-off reservation request information Brq with reference to the dispatch status DB 32, and arranges a reservation of the reservation-based dispatch of the first pickup and drop-off vehicle 110. When the reservation-based dispatch is set in association with the flight FL as illustrated in FIG. 1, the flight operation information obtaining section 14 accesses an aircraft operation DB 201 of the aircraft management system 200 to obtain flight operation information Fif indicating the operation status of the flight FL.

When a delay is recognized in the estimated arrival time of the flight FL on the basis of the flight operation information Fif, the substitution pickup and drop-off vehicle extraction section 15 executes first substitution pickup and drop-off vehicle extraction processing to extract the second pickup and drop-off vehicle 120 available to dispatch for the estimated arrival time after the delay on the basis of the dispatch status information of the dispatch status DB 32. In addition, when a change of the arrival point of the flight FL is recognized on the basis of the flight operation information Fif, the substitution pickup and drop-off vehicle extraction section 15 executes second substitution pickup and drop-off vehicle extraction processing to extract a second pickup and drop-off vehicle 120 available to dispatch for the port Fa2 that is an arrival point after the change on the basis of the dispatch status information of the dispatch status DB 32.

When the substitution pickup and drop-off vehicle extraction section 15 extracts the second pickup and drop-off vehicle 120, the dispatch cancellation confirmation section 16 transmits, to the communication device 111 of the first pickup and drop-off vehicle 110, dispatch cancellation confirmation information Cci for asking whether to accept the cancellation of the reservation-based dispatch. In this case, when the delay time of the estimated arrival time is less than a predetermined time or when the distance L (see FIG. 1) between the port Fa1 that is an arrival point before the change and the port Fa2 that is an arrival point after the change is less than a predetermined distance as described below, the dispatch cancellation confirmation information Cci may be transmitted to the communication device 111. In addition, the dispatch cancellation confirmation information Cci may include information related to the demand for dispatch using an idle time caused by the cancellation of the reservation-based dispatch. The demand for dispatch is recognized on the basis of the dispatch status DB 32.

When the dispatched pickup and drop-off vehicle changing section 17 receives dispatch cancellation request information Crq transmitted from the communication device 111 in accordance with an operation of cancelling the reservation-based dispatch by the driver D1 of the first pickup and drop-off vehicle 110 who confirms the dispatch cancellation confirmation information Cci, the dispatched pickup and drop-off vehicle changing section 17 cancels the arrangement of the reservation-based dispatch of the first pickup and drop-off vehicle 110. The dispatch cancellation request information Crq is for requesting the reservation-based dispatch to be canceled. The dispatched pickup and drop-off vehicle changing section 17 then arranges the dispatch of the second pickup and drop-off vehicle 120 that covers the flight FL after the delay in the estimated arrival time or the change of the arrival point.

The driver selection condition information obtaining section 18 extracts and obtains driver selection condition information indicating a selection condition for a desired driver from the pickup and drop-off reservation request information Brq described above. The selection condition for a desired driver is presented when the user U reserves a pickup and drop-off vehicle. When the driver selection condition information obtaining section 18 obtains the driver selection condition information, the substitution pickup and drop-off vehicle extraction section 15 extracts a second pickup and drop-off vehicle 120 driven by a driver D2 who satisfies the driver selection condition.

The additional reward imparting section 19 executes processing for imparting an additional reward to the driver D1 when a delay is caused in the arrival time of the flight FL or the arrival point is changed and then the driver D1 of the first pickup and drop-off vehicle 110 does not cancel the reservation-based dispatch and chooses to stand by to cover the delay or pick up the user U at the arrival point after the change. As the additional reward, for example, an increasing fare corresponding to the standby time, an increasing fare corresponding to the moving distance to the arrival point after the change, or the like is applied.

### 3. Dispatched Pickup and Drop-off Vehicle Changing Processing

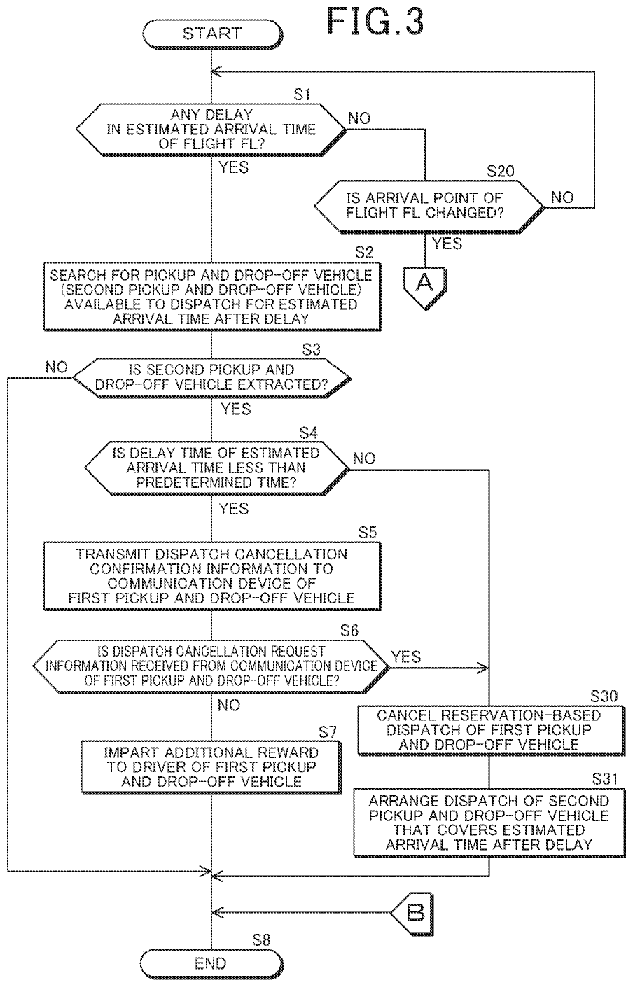

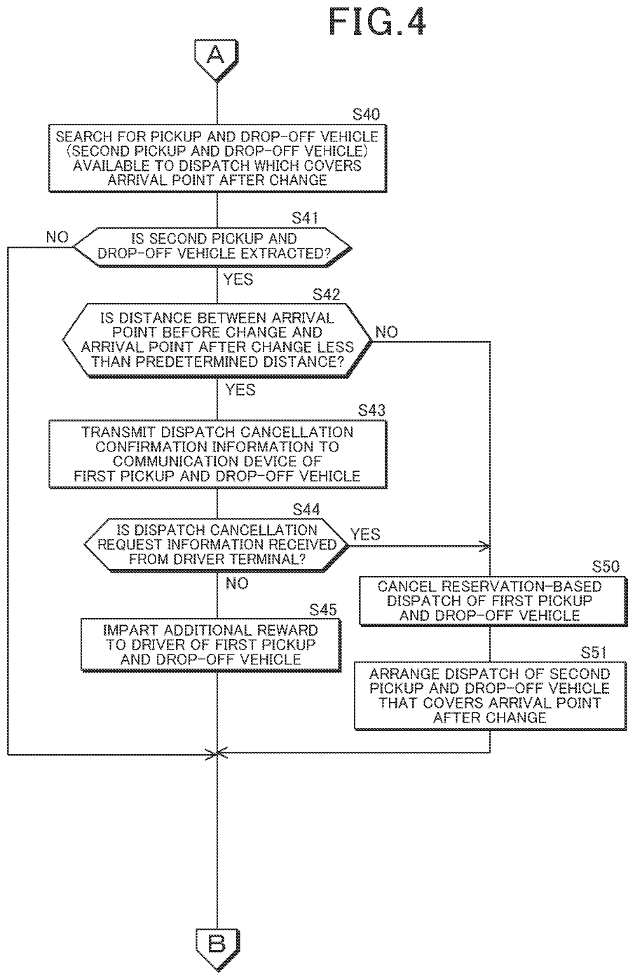

A procedure of the dispatched pickup and drop-off vehicle changing processing executed by the pickup and drop-off vehicle management system 1 in the situation illustrated in FIG. 1 will be described in accordance with the flowcharts illustrated in FIGS. 3 and 4. The pickup and drop-off vehicle management system 1 executes the processing compliant with the flowcharts illustrated in FIGS. 3 and 4 when the reservation-based dispatch of the first pickup and drop-off vehicle 110 with the port Fa1 that is the arrival point of the flight FL as a pickup point is arranged in associated with the flight FL as illustrated in FIG. 1.

Through the processing in steps S1 and S20 of FIG. 3, the substitution pickup and drop-off vehicle extraction section 15 determines whether a delay is caused in the estimated arrival time of the flight FL in step S1 on the basis of the flight operation information Fif (see FIG. 2) related to the flight FL obtained by the flight operation information obtaining section 14. In addition, in step S20, the substitution pickup and drop-off vehicle extraction section 15 determines whether the arrival point of the flight FL is changed. The substitution pickup and drop-off vehicle extraction section 15 then advances the processing from step S1 to step S2 when a delay is caused in the estimated arrival time of the flight FL, and advances the processing from step S20 to step S40 of FIG. 4 when the arrival point of the flight FL is changed.

In step S2, the substitution pickup and drop-off vehicle extraction section 15 searches the pickup and drop-off vehicle (second pickup and drop-off vehicle) 120 capable of picking up the user U at the port Fa1 that is an arrival point at the estimated arrival time after the delay with reference to the dispatch status DB 32. The substitution pickup and drop-off vehicle extraction section 15 advances the processing to step S4 when the second pickup and drop-off vehicle 120 is extracted in subsequent step S3, and advances the processing to step S8 when the second pickup and drop-off vehicle 120 is not extracted. At this point, when the second pickup and drop-off vehicle 120 is not extracted and the driver D1 of the first pickup and drop-off vehicle 110 stands by at the port Fa1 until the arrival of the delayed flight FL to pick up the user U, an additional reward may be imparted to the driver D1.

In step S4, the dispatch cancellation confirmation section 16 determines whether the delay time of the estimated arrival time of the flight FL is less than a predetermined time. The dispatch cancellation confirmation section 16 then advances the processing to step S5 when the delay time of the estimated arrival time of the flight FL is less than the predetermined time, and advances the processing to step S30 when the delay time of the estimated arrival time of the flight FL is more than or equal to the predetermined time.

In step S5, the dispatch cancellation confirmation section 16 transmits, to the communication device 111 of the first pickup and drop-off vehicle 110, the dispatch cancellation confirmation information Cci for asking whether to accept the cancellation of the reservation-based dispatch. In next step S6, the dispatch cancellation confirmation section 16 determines whether the dispatch cancellation request information Crq for requesting the reservation-based dispatch to be canceled is received from the communication device 111 of the first pickup and drop-off vehicle 110. The dispatch cancellation confirmation section 16 then advances the processing to step S30 when the dispatch cancellation request information Crq is received, and advances the processing to step S7 when the dispatch cancellation request information Crq is not received.

In step S30, the dispatched pickup and drop-off vehicle changing section 17 cancels the arrangement of the reservation-based dispatch of the first pickup and drop-off vehicle 110. In next step S31, the dispatched pickup and drop-off vehicle changing section 17 arranges the dispatch of the second pickup and drop-off vehicle 120 to the port Fa1 that covers the flight FL whose estimated time of arrival is changed, and advances the processing to step S8. In step S7, the additional reward imparting section 19 imparts an additional reward to the driver D1 of the first pickup and drop-off vehicle 110 who does not cancel the arrangement of the reservation-based dispatch and chooses to stand by to cover the estimated time of the arrival.

In step S40 of FIG. 4, the substitution pickup and drop-off vehicle extraction section 15 searches for a pickup and drop-off vehicle (second pickup and drop-off vehicle) 120 capable of picking up the user U at the port Fa2 that is the arrival point of the flight FL after the change with reference to the dispatch status DB 32. The substitution pickup and drop-off vehicle extraction section 15 advances the processing to step S42 when the second pickup and drop-off vehicle 120 is extracted in subsequent step S41, and advances the processing to step S8 of FIG. 3 when the second pickup and drop-off vehicle 120 is not extracted. At this point, when the second pickup and drop-off vehicle 120 is not extracted and the driver D1 of the first pickup and drop-off vehicle 110 moves to the port Fa2 that is the arrival point of the flight FL after the change to pick up the user U, an additional reward may be imparted to the driver D1.

In step S42, the dispatch cancellation confirmation section 16 determines whether the distance L (see FIG. 1) between the port Fa1 that is an arrival point of the flight FL before the change and the port Fa2 that is an arrival point after the change is less than a predetermined distance. The dispatch cancellation confirmation section 16 then advances the processing to step S43 when the distance L is less than the predetermined distance, and advances the processing to step S50 when the distance L is more than or equal to the predetermined distance.

In step S43, the dispatch cancellation confirmation section 16 transmits, to the communication device 111 of the first pickup and drop-off vehicle 110, the dispatch cancellation confirmation information Cci for asking whether to accept the cancellation of the reservation-based dispatch. In next step S44, the dispatch cancellation confirmation section 16 determines whether the dispatch cancellation request information Crq for requesting the reservation-based dispatch to be canceled is received from the communication device 111 of the first pickup and drop-off vehicle 110. The dispatch cancellation confirmation section 16 then advances the processing to step S50 when the dispatch cancellation request information Crq is received, and advances the processing to step S45 when the dispatch cancellation request information Crq is not received.

In step S50, the dispatched pickup and drop-off vehicle changing section 17 cancels the arrangement of the reservation-based dispatch of the first pickup and drop-off vehicle 110. In next step S51, the dispatched pickup and drop-off vehicle changing section 17 arranges the dispatch of the second pickup and drop-off vehicle 120 to the port Fa2 that covers the flight FL whose arrival location is changed from the port Fa1 to the port Fa2, and advances the processing to step S8 of FIG. 3. In step S45, the additional reward imparting section 19 imparts an additional reward to the driver D1 of the first pickup and drop-off vehicle 110 who does not cancel the arrangement of the reservation-based dispatch and chooses to move to the arrival point after the change.

### 4. Other Embodiments

In the embodiment described above, the substitution pickup and drop-off vehicle extraction section 15 executes the first substitution pickup and drop-off vehicle extraction processing that covers a delay in the estimated arrival time of the flight FL and the second substitution pickup and drop-off vehicle extraction processing that covers a change of the arrival point of the flight FL, and extracts a second pickup and drop-off vehicle 120 that is substitutable for the first pickup and drop-off vehicle 110. In another embodiment, the substitution pickup and drop-off vehicle extraction section 15 may be configured to execute only one of the first substitution pickup and drop-off vehicle extraction processing and the second substitution pickup and drop-off vehicle extraction processing.

In the embodiment described above, when the delay time of the estimated arrival time of the flight FL is less than the predetermined time and when the distance between the arrival point of the flight FL before the change and the arrival point after the change is more than or equal to the predetermined distance, the dispatch cancellation confirmation section 16 transmits the dispatch cancellation confirmation information to the communication device 111 of the first pickup and drop-off vehicle 110. In another embodiment, when a delay is caused in the estimated arrival time of the flight FL, the dispatch cancellation confirmation information may be transmitted to the communication device 111 of the first pickup and drop-off vehicle 110 regardless of whether the delay time is less than the predetermined time. In addition, when the arrival point of the flight FL is changed, the dispatch cancellation confirmation information may be transmitted to the communication device 111 of the first pickup and drop-off vehicle 110 regardless of whether the distance between the arrival point before the change and the arrival point after the change is less than the predetermined distance.

In the embodiment described above, the driver selection condition information obtaining section 18 is included and the substitution pickup and drop-off vehicle extraction section 15 extracts a second pickup and drop-off vehicle 120 driven by a driver who meets a selection condition for a driver presented by the user U. In another embodiment, the driver selection condition information obtaining section 18 may be omitted.

In the embodiment described above, the additional reward imparting section 19 is included and executes the processing of imparting an additional reward to the driver D1 of the first pickup and drop-off vehicle 110 who does not cancel the reservation-based dispatch when a delay is caused in the estimated arrival time of the flight FL or the arrival point is changed. In another embodiment, the additional reward imparting section 19 may be omitted.

In the embodiment described above, when a delay in the flight FL or a change of the arrival point causes the time of the arrival of the user U at the pickup point of the pickup and drop-off vehicle to be delayed or causes the pickup point to be changed, the pickup and drop-off vehicle management system 1 allows the driver D1 of the first pickup and drop-off vehicle 110 to cancel the reservation-based dispatch and arranges the second pickup and drop-off vehicle 120 that substitutes the first pickup and drop-off vehicle 110. In another embodiment, even when a factor other than a delay in the flight FL or a change of the arrival point causes the time of the arrival of the user U at the pickup point to be delayed or causes the pickup point to be changed, the driver D1 of the first pickup and drop-off vehicle 110 may be allowed to cancel the reservation-based dispatch and the second pickup and drop-off vehicle 120 that substitutes the first pickup and drop-off vehicle 110 may be arranged.

In this case, the pickup and drop-off vehicle management system 1 includes, for example, a user movement information obtaining section that obtains user movement information transmitted from the user terminal 50 to the pickup and drop-off vehicle management system 1. The substitution pickup and drop-off vehicle extraction section 15 then recognizes a delay in the arrival of the user U to the pickup point or a change of the pickup point on the basis of the movement status of the user U and the status of a notification of a delay to the pickup point or a change of the pickup point corresponding to the movement status indicated by the user movement information.

In addition, in an embodiment, the pickup and drop-off vehicle management system according to the present disclosure may be applied to a management system that makes overall arrangements for a movement plan including an aircraft such as an eVTOL and other means of transportation.

It is to be noted that FIG. 2 is a schematic diagram in which the functional components of the pickup and drop-off vehicle management system 1 are divided in accordance with the main processing contents for facilitating the understandings of the invention according to the present application. The components of the pickup and drop-off vehicle management system 1 may be configured in accordance with other division. In addition, the processing of each of the components may be executed by one hardware unit or executed by a plurality of hardware units. In addition, the processing by each of the components illustrated in FIGS. 3 and 4 may be executed by one program or executed by a plurality of programs.

### 5. Configurations Supported by Embodiments Above

The embodiments described above are specific examples of the following configurations.

(Configuration 1) A pickup and drop-off vehicle management system including: a dispatch status information obtaining section configured to obtain dispatch status information indicating a dispatch status of each of a plurality of pickup and drop-off vehicles; a pickup and drop-off vehicle reservation acceptance section configured to receive pickup and drop-off reservation request information transmitted from a user terminal that is used by a user who wants to use a pickup and drop-off vehicle and accept a reservation of a pickup and drop-off vehicle by the user; a reservation-based dispatch arrangement section configured to extract, on the basis of the dispatch status information, a first pickup and drop-off vehicle available to reservation-based dispatch which meets a dispatch reservation condition and arrange the reservation-based dispatch of the first pickup and drop-off vehicle, the dispatch reservation condition being indicated by the pickup and drop-off reservation request information; a flight operation information obtaining section configured to obtain flight operation information when the reservation-based dispatch uses an arrival point of a target flight as a pickup point of the user and the estimated pickup time of the reservation-based dispatch is set in association with the estimated arrival time of the target flight at the arrival point, the target flight being used by the user, the flight operation information indicating an operation status of the target flight; a substitution pickup and drop-off vehicle extraction section configured to execute at least one of first substitution pickup and drop-off vehicle extraction processing and second substitution pickup and drop-off vehicle extraction processing, the first substitution pickup and drop-off vehicle extraction processing extracting, when a delay in the estimated arrival time of the target flight is recognized on the basis of the flight operation information, a second pickup and drop-off vehicle available to dispatch for the estimated arrival time after the delay on the basis of the dispatch status information, the second substitution pickup and drop-off vehicle extraction processing extracting, when a change of the arrival point of the target flight is recognized on the basis of the flight operation information, a second pickup and drop-off vehicle available to dispatch at the arrival point after the change on the basis of the dispatch status information; a dispatch cancellation confirmation section configured to transmit dispatch cancellation confirmation information to a driver terminal when the substitution pickup and drop-off vehicle extraction section extracts the second pickup and drop-off vehicle, the driver terminal being used by a driver of the first pickup and drop-off vehicle, the dispatch cancellation confirmation information being for asking whether to accept the cancellation of the reservation-based dispatch; and a dispatched pickup and drop-off vehicle changing section configured to cancel the arrangement of the reservation-based dispatch of the first pickup and drop-off vehicle when dispatch cancellation request information is received, and arrange dispatch of the second pickup and drop-off vehicle that covers the target flight after the delay in the estimated time of the arrival or the change of the arrival point, the dispatch cancellation request information being transmitted from the driver terminal upon reception of the dispatch cancellation confirmation information and being for requesting the reservation-based dispatch to be canceled.

The pickup and drop-off vehicle management system according to Configuration 1 makes it possible to reduce losses that a driver of a pickup and drop-off vehicle reserved for dispatch with the arrival location of a flight as a pickup place may have due to the changed schedule of the target flight while avoiding disrupting the movement of the user having the reservation of the dispatch from the arrival location.

(Configuration 2) The pickup and drop-off vehicle management system according to Configuration 1, in which the dispatch cancellation confirmation information includes information related to a demand for dispatching the first pickup and drop-off vehicle that is idle due to the cancellation of the reservation-based dispatch.

The pickup and drop-off vehicle management system according to Configuration 2 allows the driver of the first pickup and drop-off vehicle to confirm the presence or absence of the demand for dispatch undertakable in substitution for the reservation-based dispatch and determine whether to cancel the reservation-based dispatch.

(Configuration 3) The pickup and drop-off vehicle management system according to Configuration 1 or 2, in which the dispatch cancellation confirmation section transmits the dispatch cancellation confirmation information to the driver terminal when a delay time of the estimated arrival time of the target flight is less than a predetermined time or when a distance between an arrival point of the target flight after the change and the arrival point before the change is less than a predetermined distance, and the dispatched pickup and drop-off vehicle changing section cancels the arrangement of the reservation-based dispatch of the first pickup and drop-off vehicle regardless of reception of the dispatch cancellation request information from the driver terminal and arranges the dispatch of the second pickup and drop-off vehicle when the delay time of the estimated arrival time of the target flight is more than or equal to the predetermined time or when the distance between the arrival point of the target flight after the change and the arrival point before the change is more than or equal to the predetermined distance.

The pickup and drop-off vehicle management system according to Configuration 3 makes it possible to automatically cancel the arrangement of the reservation-based dispatch of the first pickup and drop-off vehicle and provide convenience to the driver of the first pickup and drop-off vehicle when the driver of the first pickup and drop-off vehicle is supposed to have great losses due to a delay in the estimated arrival time of the target flight or a change of the arrival point of the target flight.

(Configuration 4) The pickup and drop-off vehicle management system according to any one of Configurations 1 to 3, including a driver selection condition information obtaining section configured to obtain driver selection condition information indicating a selection condition for a driver of a pickup and drop-off vehicle designated by the user, in which the substitution pickup and drop-off vehicle extraction section extracts the second pickup and drop-off vehicle from pickup and drop-off vehicles to be driven by drivers who satisfy the selection condition indicated by the driver selection condition information.

The pickup and drop-off vehicle management system according to Configuration 4 makes it possible to prevent a pickup and drop-off vehicle to be driven by a driver against the user's will from being selected as a substitution pickup and drop-off vehicle.

(Configuration 5) The pickup and drop-off vehicle management system according to any one of Configurations 1 to 4, including an additional reward imparting section configured to execute processing for imparting an additional reward to the driver of the first pickup and drop-off vehicle when the driver of the first pickup and drop-off vehicle does not cancel the reservation-based dispatch and stands by to cover the delay in the estimated arrival time of the target flight or covers a change of the pickup point of the user corresponding to the change of the arrival point of the target flight.

The pickup and drop-off vehicle management system according to Configuration 5 makes it possible to prompt the driver of the first pickup and drop-off vehicle to refrain from cancelling the reservation-based dispatch by using an additional reward to compensate for the losses that the driver of the first pickup and drop-off vehicle may have due to the delay in the estimated arrival time of the target flight or the change of the arrival point of the target flight.

(Configuration 6) A pickup and drop-off vehicle management system including: a dispatch status information obtaining section configured to obtain dispatch status information indicating a dispatch status of each of a plurality of pickup and drop-off vehicles; a pickup and drop-off vehicle reservation acceptance section configured to receive pickup and drop-off reservation request information transmitted from a user terminal that is used by a user who wants to use a pickup and drop-off vehicle and accept a reservation of a pickup and drop-off vehicle by the user; a reservation-based dispatch arrangement section configured to extract, on the basis of the dispatch status information, a first pickup and drop-off vehicle available to reservation-based dispatch which meets a dispatch reservation condition and arrange the reservation-based dispatch of the first pickup and drop-off vehicle, the dispatch reservation condition being indicated by the pickup and drop-off reservation request information; a user movement information obtaining section configured to obtain user movement information indicating a movement status of the user; a substitution pickup and drop-off vehicle extraction section configured to execute at least one of first substitution pickup and drop-off vehicle extraction processing and second substitution pickup and drop-off vehicle extraction processing, the first substitution pickup and drop-off vehicle extraction processing extracting, when a delay is recognized in arrival of the user with respect to an estimated pickup time at a pickup point set by the reservation-based dispatch on the basis of the user movement information, a second pickup and drop-off vehicle available to dispatch for the estimated arrival time after the delay on the basis of the dispatch status information, the second substitution pickup and drop-off vehicle extraction processing extracting, when a change of the pickup point of the user from the pickup point set by the reservation-based dispatch is recognized on the basis of the user movement information, a second pickup and drop-off vehicle available to dispatch at the pickup point after the change on the basis of the dispatch status information; a dispatch cancellation confirmation section configured to transmit dispatch cancellation confirmation information to a driver terminal when the substitution pickup and drop-off vehicle extraction section extracts the second pickup and drop-off vehicle, the driver terminal being used by a driver of the first pickup and drop-off vehicle, the dispatch cancellation confirmation information being for asking whether to accept the cancellation of the reservation-based dispatch; and a dispatched pickup and drop-off vehicle changing section configured to cancel the arrangement of the reservation-based dispatch of the first pickup and drop-off vehicle when dispatch cancellation request information is received, and arrange dispatch of the second pickup and drop-off vehicle that covers a delay of the user to the pickup point or the change of the pickup point of the user, the dispatch cancellation request information being transmitted from the driver terminal upon reception of the dispatch cancellation confirmation information, the dispatch cancellation request information being for requesting the reservation-based dispatch to be canceled.

The pickup and drop-off vehicle management system according to Configuration 6 makes it possible to reduce the losses that a driver of a pickup and drop-off vehicle reserved for dispatch by the reservation-based dispatch may have when it is recognized that a variety of factors including a delay in the arrival of a flight that is used by the user or a change of the arrival point cause the arrival of the user to be delayed with respect to the estimated pickup time at the pickup point set by the reservation-based dispatch or causes the pickup point of the user to be changed while avoiding disrupting movement from the arrival point of the user who reserves the dispatch.

(Configuration 7) A pickup and drop-off vehicle management method that is executed by a computer, the method including: a dispatch status information obtaining step of obtaining dispatch status information indicating a dispatch status of each of a plurality of pickup and drop-off vehicles; a pickup and drop-off vehicle reservation acceptance step of receiving pickup and drop-off reservation request information transmitted from a user terminal that is used by a user who wants to use a pickup and drop-off vehicle, and accepting a reservation of a pickup and drop-off vehicle by the user; a reservation-based dispatch arrangement step of extracting, on the basis of the dispatch status information, a first pickup and drop-off vehicle available to reservation-based dispatch which meets a dispatch reservation condition, and arranging the reservation-based dispatch of the first pickup and drop-off vehicle, the dispatch reservation condition being indicated by the pickup and drop-off reservation request information; a flight operation information obtaining step of obtaining flight operation information when the reservation-based dispatch uses an arrival point of a target flight as a pickup point of the user and the estimated pickup time of the reservation-based dispatch is set in association with the estimated arrival time of the target flight at the arrival point, the target flight being used by the user, the flight operation information indicating an operation status of the target flight; a substitution pickup and drop-off vehicle extraction step of executing at least one of first substitution pickup and drop-off vehicle extraction processing and second substitution pickup and drop-off vehicle extraction processing, the first substitution pickup and drop-off vehicle extraction processing extracting, when a delay in the estimated arrival time of the target flight is recognized on the basis of the flight operation information, a second pickup and drop-off vehicle available to dispatch for the estimated arrival time after the delay on the basis of the dispatch status information, the second substitution pickup and drop-off vehicle extraction processing extracting, when a change of the arrival point of the target flight is recognized on the basis of the flight operation information, a second pickup and drop-off vehicle available to dispatch at the arrival point after the change on the basis of the dispatch status information; a dispatch cancellation confirmation step of transmitting dispatch cancellation confirmation information to a driver terminal when the second pickup and drop-off vehicle is extracted in the substitution pickup and drop-off vehicle extraction step, the driver terminal being used by a driver of the first pickup and drop-off vehicle, the dispatch cancellation confirmation information being for asking whether to accept the cancellation of the reservation-based dispatch; and a dispatched pickup and drop-off vehicle changing step of canceling the arrangement of the reservation-based dispatch of the first pickup and drop-off vehicle when dispatch cancellation request information is received, and arranging dispatch of the second pickup and drop-off vehicle that covers the target flight after the delay in the estimated time of the arrival or the change of the arrival point, the dispatch cancellation request information being transmitted from the driver terminal upon reception of the dispatch cancellation confirmation information, the dispatch cancellation request information being for requesting the reservation-based dispatch to be canceled.

The execution of the pickup and drop-off vehicle management method according to Configuration 7 by the computer makes it possible to obtain the workings and effects similar to those of the pickup and drop-off vehicle management system according to Configuration 1.

### REFERENCE SIGNS LIST

1 pickup and drop-off vehicle management system
10 processor
11 dispatch status information obtaining section
12 pickup and drop-off vehicle reservation acceptance section
13 reservation-based dispatch arrangement section
14 flight operation information obtaining section
15 substitution pickup and drop-off vehicle extraction section
16 dispatch cancellation confirmation section
17 dispatched pickup and drop-off vehicle changing section
18 driver selection condition information obtaining section
19 additional reward imparting section
30 memory
31 program
32 dispatch status DB
40 communication unit
50 user terminal
100 aircraft
110 first pickup and drop-off vehicle
111 communication device of a first pickup and drop-off vehicle
120 second pickup and drop-off vehicle
121 communication device of a second pickup and drop-off vehicle
200 aircraft management system
201 aircraft operation DB
300 communication network
U user
D1 driver of a first pickup and drop-off vehicle

What is claimed is:

1. A pickup and drop-off vehicle management system comprising:
a dispatch status information obtaining section configured to obtain dispatch status information indicating a dispatch status of each of a plurality of pickup and drop-off vehicles;
a pickup and drop-off vehicle reservation acceptance section configured to receive pickup and drop-off reservation request information transmitted from a user terminal that is used by a user who wants to use a pickup and drop-off vehicle and accept a reservation of a pickup and drop-off vehicle by the user;
a reservation-based dispatch arrangement section configured to extract, on the basis of the dispatch status information, a first pickup and drop-off vehicle available for reservation-based dispatch which meets a dispatch reservation condition and arrange the reservation-based dispatch of the first pickup and drop-off vehicle, the dispatch reservation condition being indicated by the pickup and drop-off reservation request information;
a flight operation information obtaining section configured to obtain flight operation information when the reservation-based dispatch uses an arrival point of a target flight as a pickup point of the user and estimated pickup time of the reservation-based dispatch is set in association with estimated arrival time of the target flight at the arrival point, the target flight being used by the user, the flight operation information indicating an operation status of the target flight;
a substitution pickup and drop-off vehicle extraction section configured to execute at least one of first substitution pickup and drop-off vehicle extraction processing and second substitution pickup and drop-off vehicle extraction processing, the first substitution pickup and drop-off vehicle extraction processing extracting, when a delay is recognized in the estimated arrival time of the target flight on the basis of the flight operation information, a second pickup and drop-off vehicle available to dispatch for estimated arrival time after the delay on the basis of the dispatch status information, the second substitution pickup and drop-off vehicle extraction processing extracting, when a change of the arrival point of the target flight is recognized on the basis of the flight operation information, a second pickup and drop-off vehicle available to dispatch at an arrival point after the change on the basis of the dispatch status information;
a dispatch cancellation confirmation section configured to transmit dispatch cancellation confirmation information to a driver terminal when the substitution pickup and drop-off vehicle extraction section extracts the second pickup and drop-off vehicle, the driver terminal being used by a driver of the first pickup and drop-off vehicle, the dispatch cancellation confirmation information being for asking whether to accept the cancellation of the reservation-based dispatch; and
a dispatched pickup and drop-off vehicle changing section configured to cancel the arrangement of the reservation-based dispatch of the first pickup and drop-off vehicle when dispatch cancellation request information is received and arrange dispatch of the second pickup and drop-off vehicle that covers the target flight after the delay in the estimated time of the arrival or the change of the arrival point, the dispatch cancellation request information being transmitted from the driver terminal upon reception of the dispatch cancellation confirmation information, the dispatch cancellation request information being for requesting the reservation-based dispatch to be canceled.

2. The pickup and drop-off vehicle management system according to claim 1, wherein the dispatch cancellation confirmation information includes information related to a demand for dispatching the first pickup and drop-off vehicle that is idle due to the cancelling of the reservation-based dispatch.

3. The pickup and drop-off vehicle management system according to claim 1, wherein
the dispatch cancellation confirmation section transmits the dispatch cancellation confirmation information to the driver terminal when a delay time of the estimated arrival time of the target flight is less than a predetermined time or when a distance between an arrival point of the target flight after the change and the arrival point before the change is less than a predetermined distance, and
the dispatched pickup and drop-off vehicle changing section cancels the arrangement of the reservation-based dispatch of the first pickup and drop-off vehicle regardless of reception of the dispatch cancellation request information from the driver terminal and arranges the dispatch of the second pickup and drop-off vehicle when the delay time of the estimated arrival time of the target flight is more than or equal to the predetermined time or when the distance between the arrival point of the target flight after the change and the arrival point before the change is more than or equal to the predetermined distance.

4. The pickup and drop-off vehicle management system according to claim 1, comprising a driver selection condition information obtaining section configured to obtain driver selection condition information indicating a selection condition for a driver of a pickup and drop-off vehicle designated by the user, wherein
the substitution pickup and drop-off vehicle extraction section extracts the second pickup and drop-off vehicle from pickup and drop-off vehicles to be driven by drivers who satisfy the selection condition indicated by the driver selection condition information.

5. The pickup and drop-off vehicle management system according to claim 1, comprising an additional reward imparting section configured to execute processing for imparting an additional reward to the driver of the first pickup and drop-off vehicle when the driver of the first pickup and drop-off vehicle does not cancel the reservation-based dispatch and stands by to cover the delay in the estimated arrival time of the target flight or covers a change of the pickup point of the user corresponding to the change of the arrival point of the target flight.

6. A pickup and drop-off vehicle management system comprising:
a dispatch status information obtaining section configured to obtain dispatch status information indicating a dispatch status of each of a plurality of pickup and drop-off vehicles;
a pickup and drop-off vehicle reservation acceptance section configured to receive pickup and drop-off reservation request information transmitted from a user terminal that is used by a user who wants to use a pickup and drop-off vehicle and accept a reservation of a pickup and drop-off vehicle by the user;
a reservation-based dispatch arrangement section configured to extract, on the basis of the dispatch status information, a first pickup and drop-off vehicle available to reservation-based dispatch which meets a dispatch reservation condition and arrange the reservation-based dispatch of the first pickup and drop-off vehicle, the dispatch reservation condition being indicated by the pickup and drop-off reservation request information;
a user movement information obtaining section configured to obtain user movement information indicating a movement status of the user;
a substitution pickup and drop-off vehicle extraction section configured to execute at least one of first substitution pickup and drop-off vehicle extraction processing and second substitution pickup and drop-off vehicle extraction processing, the first substitution pickup and drop-off vehicle extraction processing extracting, when a delay is recognized in arrival of the user with respect to an estimated pickup time at a pickup point set by the reservation-based dispatch on the basis of the user movement information, a second pickup and drop-off vehicle available to dispatch for estimated arrival time after a delay on the basis of the dispatch status information, the second substitution pickup and drop-off vehicle extraction processing extracting, when a change of the pickup point of the user from the pickup point set by the reservation-based dispatch is recognized on the basis of the user movement information, a second pickup and drop-off vehicle available to dispatch at a pickup point after the change on the basis of the dispatch status information;
a dispatch cancellation confirmation section configured to transmit dispatch cancellation confirmation information to a driver terminal when the substitution pickup and drop-off vehicle extraction section extracts the second pickup and drop-off vehicle, the driver terminal being used by a driver of the first pickup and drop-off vehicle, the dispatch cancellation confirmation information being for asking whether to accept the cancellation of the reservation-based dispatch; and
a dispatched pickup and drop-off vehicle changing section configured to cancel the arrangement of the reservation-based dispatch of the first pickup and drop-off vehicle when dispatch cancellation request information is received and arrange dispatch of the second pickup and drop-off vehicle that covers a delay of the user to the pickup point or the change of the pickup point of the user, the dispatch cancellation request information being transmitted from the driver terminal upon reception of the dispatch cancellation confirmation information, the dispatch cancellation request information being for requesting the reservation-based dispatch to be canceled.

7. A pickup and drop-off vehicle management method that is executed by a computer, the method comprising:
a dispatch status information obtaining step of obtaining dispatch status information indicating a dispatch status of each of a plurality of pickup and drop-off vehicles;
a pickup and drop-off vehicle reservation acceptance step of receiving pickup and drop-off reservation request information transmitted from a user terminal that is used by a user who wants to use a pickup and drop-off vehicle and accepting a reservation of a pickup and drop-off vehicle by the user;
a reservation-based dispatch arrangement step of extracting, on the basis of the dispatch status information, a first pickup and drop-off vehicle available to reservation-based dispatch which meets a dispatch reservation condition and arranging the reservation-based dispatch of the first pickup and drop-off vehicle, the dispatch reservation condition being indicated by the pickup and drop-off reservation request information;
a flight operation information obtaining step of obtaining flight operation information when the reservation-based dispatch uses an arrival point of a target flight as a pickup point of the user and estimated pickup time of the reservation-based dispatch is set in association with estimated arrival time of the target flight at the arrival point, the target flight being used by the user, the flight operation information indicating an operation status of the target flight;
a substitution pickup and drop-off vehicle extraction step of executing at least one of first substitution pickup and drop-off vehicle extraction processing and second substitution pickup and drop-off vehicle extraction processing, the first substitution pickup and drop-off vehicle extraction processing extracting, when a delay in the estimated arrival time of the target flight is recognized on the basis of the flight operation information, a second pickup and drop-off vehicle available to dispatch for estimated arrival time after the delay on the basis of the dispatch status information, the second substitution pickup and drop-off vehicle extraction processing extracting, when a change of the arrival point of the target flight is recognized on the basis of the flight operation information, a second pickup and drop-off vehicle available to dispatch at an arrival point after the change on the basis of the dispatch status information;
a dispatch cancellation confirmation step of transmitting dispatch cancellation confirmation information to a driver terminal when the second pickup and drop-off vehicle is extracted in the substitution pickup and drop-off vehicle extraction step, the driver terminal being used by a driver of the first pickup and drop-off vehicle, the dispatch cancellation confirmation information being for asking whether to accept the cancellation of the reservation-based dispatch; and
a dispatched pickup and drop-off vehicle changing step of canceling the arrangement of the reservation-based dispatch of the first pickup and drop-off vehicle when dispatch cancellation request information is received and arranging dispatch of the second pickup and drop-off vehicle that covers the target flight after the delay in the estimated arrival time or the change of the arrival point, the dispatch cancellation request information being transmitted from the driver terminal upon reception of the dispatch cancellation confirmation information, the dispatch cancellation request information being for requesting the reservation-based dispatch to be canceled.
